(19) United States
(12) Patent Application Publication
(10) Pub. No.: US 2003/0097494 A1
(43) Pub. Date: May 22, 2003

(54) Imaging device list storage

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/989,967

(22) Filed: Nov. 21, 2001

(51) Int. Cl. G06F 3/00

(52) U.S. Cl. 710/8; 710/15

(57) ABSTRACT

An improved class of imaging devices with an ability to store a list of other imaging devices of an imaging device system are described. Such storage allows for ease of management facility utilization of the listed imaging devices and update of the management facility. Additionally, synchronization of managed imaging devices across multiple management facilities is allowed. Such storage can also allow for automated discovery and updating of status and features of the listed imaging devices that are part of a managed imaging device system.

### TECHNICAL FIELD OF THE INVENTION

The present invention relates generally to imaging device management and in particular the present invention relates to management of imaging device systems over a network.

### BACKGROUND OF THE INVENTION

Computing devices are typically coupled to networks in modern computing environments. Networks in this definition include fiber optic, wire, wireless, and virtual, such as a virtual private network (VPN). In particular, imaging devices, such as printers, projectors, displays, and faxes are typically networked in modern computing environments. These imaging devices are typically set up and configured through a built-in network interface that allows them to be communicated with and configured remotely over a network. Imaging devices in organizations are typically implemented as networked imaging service providers in computer networks. In this disclosure imaging devices are intended to include, but are not limited to, printers, multi-function copiers, digital projectors, faxes, terminals, and other such imaging devices. Imaging devices typically produce either a hard or soft copy of any particular imaging job the device is given using an appropriate image generator. If the imaging device produces a hard copy, its image generator is often referred to as a print engine, which produces a hard copy on the appropriate print media. If the imaging device produces a non-permanent soft copy, its image generator may be referred to as an image projection engine, which produces the imaging job on a viewable medium, such as an LCD, a CRT or a projection screen.

When being managed or queried over the network, the imaging devices generally require a management facility, program, or protocol, generally referred to as management facilities, to interface with. These management facilities are typically specific to the device, class of device, or even device manufacturer, that is being managed or communicated with. The management facilities for imaging devices can take many forms. In this disclosure, management facilities are intended to include, but are not limited to, management programs running on multiple platforms, software drivers, and other such management programs.

FIG. 1 details a simplified diagram of a network and imaging device system. FIG. 1 includes a network backplane 100, imaging devices 102, 110, a server 106, workstations 108, and a management facility 104. Each imaging device 102, 110 contains device configuration information, device firmware/software, and gathers it own usage information and statistics, which can include such information as number of pages imaged, number of jobs received, number of copies of jobs received, and numbers of errors. Each imaging device 102, 110 is coupled to the network backplane 100 with a network interface (not shown). Imaging device 110 is functionally identical to the other imaging devices coupled to the network, but is shown in more detail to illustrate operation of an imaging device. In imaging device 110, a processor or controller 112 is coupled to the network interface, and to an image generator 114. Imaging jobs are accepted from the network backplane 100 through the network interface (not shown), and are processed and imaged by the image generator 114 with the aid of the processor 112. The management facility 104 allows management and querying of the imaging devices 102, 110 across the network backplane 100. Each imaging device 102, 110 communicates to the management facility 104 across the network backplane 100.

When managing imaging devices on a network, management facilities typically utilize a list of network addresses of the imaging devices to be communicated with and managed. This list of imaging device network addresses can either be entered manually to the management facility, loaded into the management facility from an external source, or the imaging devices can be “discovered” by the management facility over the network generating the list of addresses.

The installation of multiple management facilities by administrators on networks for convenience of management is a common practice. Additionally, over time there are often multiple upgrades of these management facilities as new versions and features are installed. Each new management facility or upgrade often requires that the list of imaging devices be discovered or loaded into the particular management facility.

Imaging devices in network imaging device systems tend to go online and offline with a relatively frequent occurrence rate. In addition, imaging devices are often removed or added to a network over time, requiring update of the management facilities' list of imaging devices. As many management facilities do not tend to be continually on, many of these changes to the imaging devices and their addresses on the network are often missed and not reflected in the list of managed imaging devices.

In addition, as stated above, the management facility, and in particular the communication protocol, can be specific to the device, class of device, or even device manufacturer, that is being managed. This can require the management facility to use specialized handling or protocols for the differing imaging devices in the network. This specialized handling can make the communication and management of the differing imaging devices complex, making automated discovery of these imaging devices by the management facility difficult.

Thus, with single or multiple management facilities, managing and communicating with a system of imaging devices with a constantly changing list of network addresses is difficult, time consuming, and inconvenient for the network administrator and users.

For the reasons stated above, and for other reasons stated below which will become apparent to those skilled in the art upon reading and understanding the present specification, there is a need in the art for a method of conveniently generating, storing and maintaining a list of imaging device network addresses in a network environment.

### SUMMARY OF THE INVENTION

The above-mentioned problems with conveniently generating, storing and maintaining a list of imaging device network addresses in a network environment are addressed by the present invention and will be understood by reading and studying the following specification.

In one embodiment, an imaging device comprises a network interface, and a controller coupled to the network interface, wherein the controller is adapted to store a list of other network addresses.

In another embodiment, a computer-usable medium having computer readable instructions stored thereon for execution by a processor to perform a method comprising determining a list of network addresses for other imaging devices similar to an imaging device, storing the list of network addresses on the imaging device, and communicating with the other similar imaging devices by referring to the list of network addresses for the other imaging devices.

In a method of operating an imaging device, the method comprises determining a list of network addresses for other imaging devices similar to the imaging device, storing the list of network addresses on the imaging device, and referring to the list of network addresses of other imaging devices for communication between imaging devices.

### BRIEF DESCRIPTION OF THE DRAWINGS

FIG. 1 is a simplified diagram of a network with imaging devices, workstations, a server, and an imaging device management facility.

FIGS. 2A and 2B are simplified diagrams of image device embodiments of the present invention.

FIGS. 3A, 3B, and 3C are simplified flowcharts of discovery methods with embodiments of the present invention.

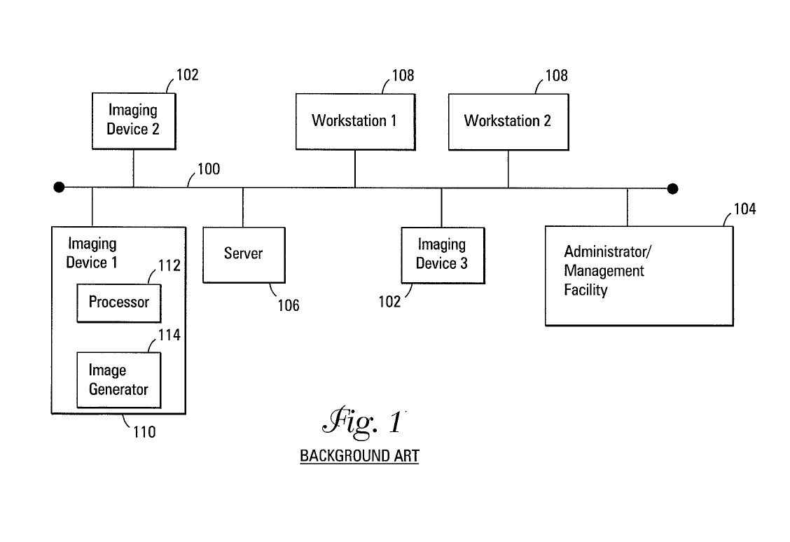

### DETAILED DESCRIPTION OF THE INVENTION

In the following detailed description of the preferred embodiments, reference is made to the accompanying drawings that form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include imaging devices that store a list of other imaging devices on the network. This allows management facilities to communicate to these imaging devices and utilize the stored list of imaging device addresses in managing the imaging device system, without the need to discover, or manually load, the imaging devices to be managed. An imaging device system for purposes of this disclosure is defined as multiple imaging devices that are networked or otherwise linked.

Specific embodiments of the present invention include, but are not limited to, imaging devices that include imaging devices that store a list of other imaging devices on the network, allowing synchronization, upgrade, and loading of a list of imaging devices on one or more management facilities on a network; imaging devices that store the list of imaging devices internally on multiple media and formats; imaging device systems that store a list of imaging devices on one or more imaging devices on a network; imaging devices that load a list of imaging devices from an external source, input a list of imaging devices manually, or discover a list of imaging devices from a network; imaging devices that can maintain and update a list of imaging devices from a network to keep the list of addresses and information current; imaging devices that can store and maintain a list of imaging devices that include supplemental information about the imaging devices on the list, such as, imaging device type, imaging device features, media types, marking material types (such as ink, toner, thermal material, etc.), imaging device configuration, imaging rate, imaging device usage information (job origin, number of pages imaged, number of copies of jobs received, number of errors, types of errors, marking material usage, marking material level, etc. ), imaging device status, etc.; imaging devices that can discover and update a list of imaging devices with the aid of a history list of previously valid imaging device addresses and supplemental information; and imaging devices that can store a list of imaging devices and include an embedded management facility or function, such as an embedded webserver.

In embodiments of present invention, the management facility may be a function of a network device, such as a master imaging device, server, workstation or other similar device. The management facility is generally a software program running on some platform or operating system, but such functionality could be expressed in firmware or even hard-coded in a device such as an application-specific integrated circuit (ASIC) chip. Imaging devices that incorporate an embedded management facility are also known. An example of such are imaging devices with embedded webservers, allowing management of themselves and other imaging devices on the network through the embedded webserver are described in the U.S. patent application Ser. No. (Attorney Docket No. 10008080-1), which is commonly assigned and is incorporated herein by reference. In general, however, the management facility includes a set of computer-readable instructions stored on a computer-usable medium for execution by a processor. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

As stated above, imaging devices embodiments of the present invention store a list of imaging devices of the network imaging device system, allowing them to become a repository of these imaging device addresses and optional supplemental information on the listed imaging devices for the network imaging device system. This allows any management facilities that are utilized to manage the network imaging device system to communicate to these repository imaging devices and utilize the stored list of imaging devices and optional supplemental information in managing the network imaging device system, without the need to discover, or manually load, the imaging devices and information. It also allows for multiple management facilities to be maintained without the need for constant resynchronization of the managed imaging device lists across these multiple management facilities. In embodiments of the present invention is preferential that the stored list of imaging devices are similar to each other and to the imaging device that stores the list. Similar imaging devices, for the purposes of this disclosure, are defined as imaging devices similar with regard to manufacturer, imaging device type, or features. Imaging device embodiments of the present invention are particularly advantageous where a management facility is embedded in one or more of the imaging devices of the imaging device system, such as the above detailed embedded webserver management facility.

The list of imaging devices can be stored in imaging device embodiments of the present invention in multiple forms of internal storage media. Such media include, but are not limited to, removable and non-removable magnetic media, optical media, dynamic random-access memory (DRAM), static random-access memory (SRAM), and electrically-erasable and programmable read-only memory (EEPROM or Flash). The format of the lists can be stored in embodiments of the present invention can be in forms that include, but are not limited to, formatted media blocks, sequential lists, linked lists, formatted files of a specified file system type, and webserver cookies.

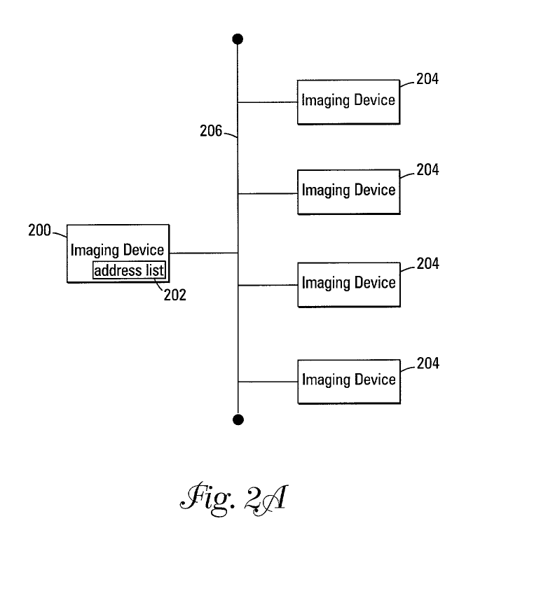

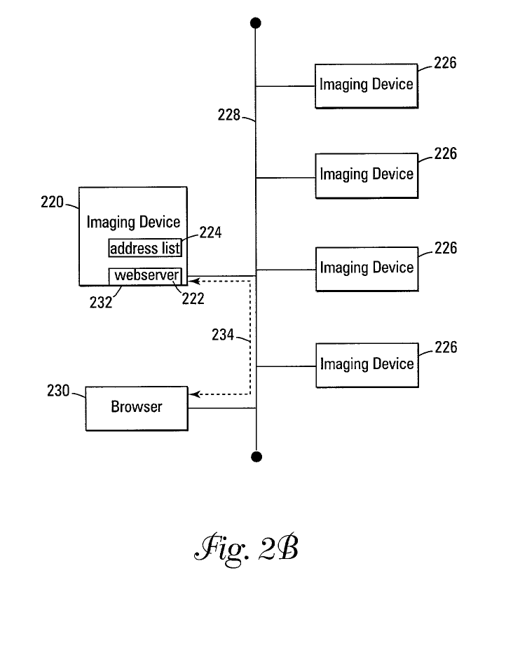

FIG. 2A shows an imaging device system with an imaging device 200 embodiment of present invention. In FIG. 2A, the imaging device embodiment of the present invention 200 stores a list 202 of imaging devices 204 of the imaging device system of the network 206.

FIG. 2B shows an imaging device system with an imaging device 220 embodiment of present invention containing an embedded management facility 222 in the form of an embedded webserver 232. In FIG. 2B, the imaging device embodiment of the present invention 220 stores a list 224 of imaging devices 226 of the imaging device system of the network 228. The management facility 222 is accessed 234 with a web browser 230, that is in communication with the embedded webserver 232 through the network 228. The list 224 of imaging devices 226 is utilized by the embedded management facility 222 of the imaging device 220 embodiment of the present invention in management of the imaging devices 220, 226 of the imaging device system of the network 228.

As an additional feature in the imaging device embodiments of the present invention the list of imaging devices, once input or loaded, can be copied and stored across multiple imaging device embodiments of the present invention. Mirroring the list provides redundancy and multiple points of availability for the network imaging device system and management facilities.

In addition to storing a list of imaging device addresses, the list of imaging devices in embodiments of the present invention can also contain supplemental information on the imaging devices of the network to aid management facility operation and efficiency. Such supplemental information can include, but is not limited to, imaging device type, imaging device status information and statistics, imaging device features, imaging device manufacture, and imaging device communication protocols and interfaces.

In storing the list of imaging devices and any supplemental information, the list of imaging devices can be input to the imaging device embodiment of the present invention manually or loaded from an external source with an appropriate protocol or file format. Alternatively, the list of imaging devices and supplemental information can be generated in imaging devices embodiments of the present invention by a process of “discovering” the other imaging devices on the network, such as described infra. The discovered list of imaging devices is then stored in the imaging device embodiment of the present invention and copied as required for storage to any additional imaging device embodiments of the present invention.

Once the list of imaging devices is loaded or discovered, the list can be maintained or updated on an ongoing basis by imaging device embodiments of the present invention using techniques similar to discovery. This process of updating of the list can be as simple as testing the network address of each imaging device in the list of imaging devices to see if a network device is still present, to processing a complete rediscovery of the imaging devices of the network. Such updates can be scheduled to occur at times and/or intervals specified by the administrator to maintain the list and supplemental information. This ongoing update of the list of imaging devices frees the management facilities from having to do a potentially lengthy discovery or update first when initialized by the manager, or from being constantly on and in communication with the network to allow tracking for themselves of the managed imaging devices on the network. As an additional aid, imaging device embodiments of the present invention can also optionally accept notifications from the managed imaging devices in the imaging device system when they go offline, online, or have a change status, maintaining a current list state.

Imaging device embodiments of the present invention can optionally maintain a history list of previously valid imaging devices of the imaging device system. Such a history list of imaging devices can also contain supplemental information on the imaging devices found at the previously valid addresses as an aid in establishing communication. This supplemental information can include, but is not limited to, imaging device type, imaging device features, imaging device manufacture, and imaging device communication protocols and interfaces. This history list can be utilized by imaging device embodiments of the present invention as an aid in discovering or maintaining the primary list of imaging devices, allowing for faster discovery of new or re-enabled imaging devices. Such a history list would aid in discovery or maintaining a primary list of imaging devices by listing the previously valid, and thus likely to be valid again, networking addresses, imaging device types, and communication protocols or interfaces, allowing them to be marked for increased imaging device list scrutiny in discovery and update.

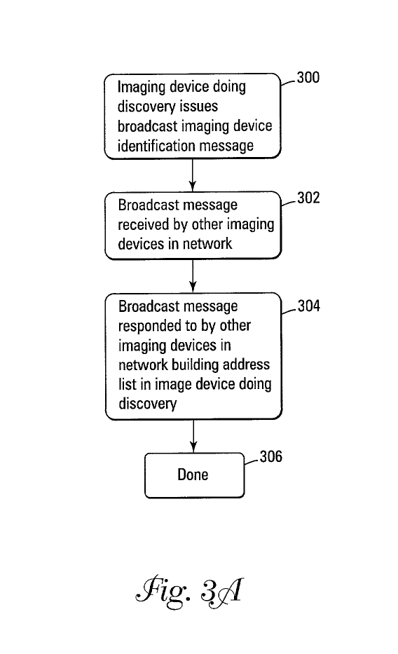

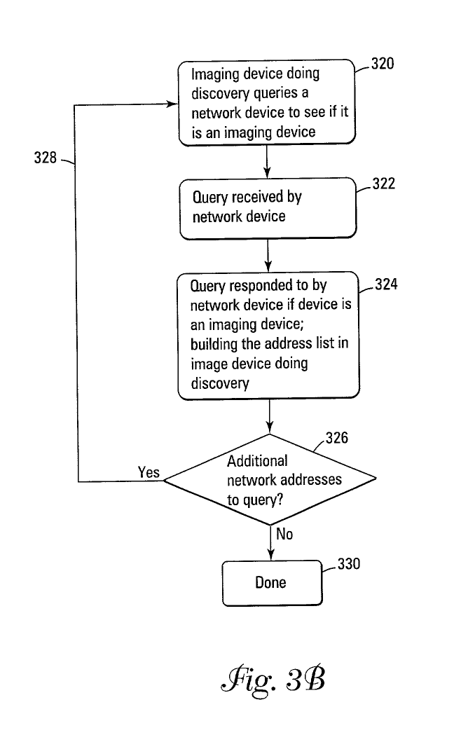

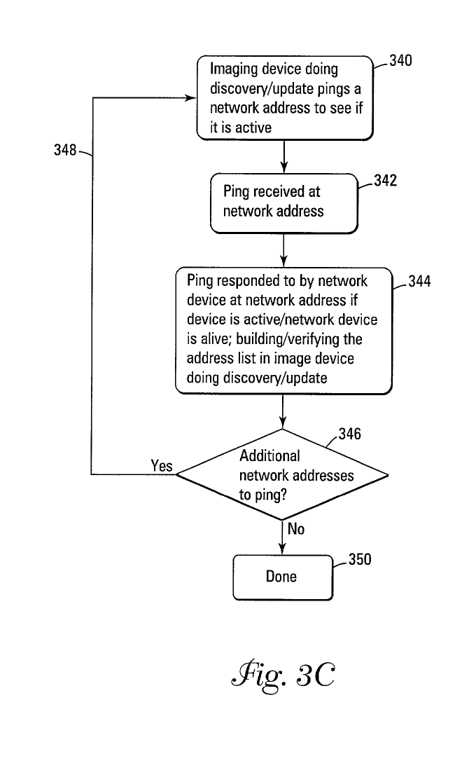

Example methods of imaging device discovery and update in imaging device embodiments of the present invention are shown in the simplified flowcharts of FIGS. 3A, 3B, and 3C.

FIG. 3A shows a simplified flowchart of an embodiment of the present invention doing imaging device discovery utilizing a “broadcast” discovery process. In FIG. 3A, an imaging device embodiment of the present invention that is doing an imaging device discovery issues 300 an imaging device identification message in broadcast mode. The broadcast imaging device identification message is received 302 by the other imaging devices on the network. The broadcast imaging device identification message is responded to 304 by the other imaging devices in the network and builds the list of imaging devices and supplemental information for the imaging device embodiment of the present invention that is doing the discovery. After all imaging devices on the network have reported, or a specified time period for response had passed, the discovery process finishes 306.

FIG. 3B shows a simplified flowchart of an embodiment of the present invention doing imaging device discovery utilizing a “querying” discovery process. In FIG. 3B, an imaging device embodiment of the present invention that is doing an imaging device discovery queries a network device 320 with protocols and/or interfaces of known imaging device types to detect if an imaging device is present at the network address. The query message is received 322 by the network device and is responded to 324 if the network device is an imaging device, enabling the imaging device embodiment of the present invention to build the list of imaging devices and supplemental information for the imaging device system. If additional network addresses remain to be queried 326, the discovery process repeats 328 to query the next network device to see if it is an imaging device. After all network devices on the network have been queried, the querying discovery process finishes 330.

FIG. 3C shows a simplified flowchart of an embodiment of the present invention doing imaging device discovery utilizing a “pinging” discovery process. A pinging discovery process differs from the querying discovery process in that the pinging process is not a full query of the network device at the targeted network address, but is a simple check to see if a network device is at the network address and that it is online and active. Therefore, the pinging discovery process is preferably utilized in embodiments of the present invention in conjunction with another discovery process to speed discovery by pre-filtering out inactive network addresses, as a quick check or update of a previously discovered/loaded list of imaging devices on the network, or as a check of history list of previously valid imaging devices. An example of such a combined process is a pinging discovery that is utilized to pre-filter out inactive network addresses and which is followed by the more resource intensive querying discovery process on the active network addresses. In FIG. 3B, an imaging device embodiment of the present invention that is doing an imaging device discovery pings a network address 340 to detect if a network device is present at the network address. The ping message is received 342 by the network device and is responded to 344 if the network device is online and active, enabling the imaging device embodiment of the present invention to build a list of imaging devices for the imaging device system. If additional network addresses remain to be pinged 346, the discovery process repeats 348 to ping the next network device to see if it is online and active. After all network devices on the network have been checked, the pinging discovery process finishes 350.

It is noted that the discovery processes of FIGS. 3A, 3B, and 3C can also be utilized to update and maintain an existing list of imaging devices once initially discovered. In particular, the pinging process of FIG. 3C is suitable for low overhead updating of an existing loaded or discovered imaging device list or of a history list of previously valid imaging devices. In an update operation the imaging devices of a list are verified and the imaging devices' status is checked. The stored list of imaging devices and any optional supplemental information is updated from the results. In addition, the update process can check a history list of previously valid imaging devices or do a discovery for any new imaging devices that have been added to the network imaging device system.

Any of the discovery processes of FIGS. 3A, 3B, and 3C can be utilized in conjunction with each other, supplementing the overall imaging device list discovery and update process. As an example, an administrator scheduling a broadcast or query discovery process to happen once a day at an off peak time and scheduling a pinging update process of the discovered imaging device list to occur at regular intervals throughout the day.

It is noted that alternative manners of imaging device list storage, utilization, and discovery/update in accordance with embodiments of the present invention are possible and should be apparent to those skilled in the art with the benefit of the present disclosure.

### CONCLUSION

An improved class of imaging devices with an ability to store a list of other imaging devices of an imaging device system have been described. Such storage allows for ease of management facility utilization of the listed imaging devices and update of the management facility. Additionally, synchronization of managed imaging devices across multiple management facilities is allowed. Such storage can also allow for automated discovery and updating of status and features of the listed imaging devices that are part of the managed imaging device system.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An imaging device comprising:
an image generator;
a network interface; and
a controller coupled to the network interface and the image generator, wherein the controller is adapted to store a list of other network addresses.

2. The imaging device of claim 1, wherein the list of other network addresses further comprises a list of other imaging device network addresses.

3. The imaging device of claim 2, wherein the list of other imaging device network addresses further comprises additional information on the other imaging devices selected from the group consisting of media types, marking material types, imaging device features, imaging device configuration, imaging device usage information, imaging device status, imaging device imaging rate, and imaging device supplemental information.

4. The imaging device of claim 1, wherein the controller is adapted to store a list of other network addresses in a media that is selected from the group consisting of SRAM, DRAM, a non-volatile memory device, a register, magnetic media, and optical media.

5. The imaging device of claim 1, wherein the controller further comprises an embedded webserver.

6. The imaging device of claim 1, wherein the list of other network addresses is in a format selected from the group consisting of a formatted memory block, a formatted media blocks, a formatted file system block, a sequential list, a linked list, and a webserver cookie.

7. The imaging device of claim 1, wherein the controller is adapted to discover the list of other network addresses.

8. The imaging device of claim 7, wherein discovering the list of other network addresses further comprises discovering the list of other network addresses with a manner selected from the group consisting of querying network addresses for known device specific interface protocols, generally broadcasting a device identification protocol for specific device types to respond to, and pinging network addresses.

9. The imaging device of claim 7, wherein discovering the list of other network addresses is scheduled to occur at specific times.

10. The imaging device of claim 7, wherein a history list of previously valid network addresses is utilized in discovering the list of other network addresses.

11. The imaging device of claim 1, wherein a network device at a network address notifies the imaging device when it going offline or coming online.

12. The imaging device of claim 1, wherein the image generator is a print engine.

13. A computer-usable medium having computer readable instructions stored thereon for execution by a processor to perform a method comprising:
determining a list of network addresses for other imaging devices similar to an imaging device;
storing the list of network addresses on the imaging device; and
communicating with the other similar imaging devices by referring to the list of network addresses for the other imaging devices.

14. The method of claim 13, wherein determining the list of network addresses for other imaging devices similar to the imaging device further comprises discovering the network addresses for other imaging devices similar to the imaging device.

15. A method of operating an imaging device, the method comprising:
determining a list of network addresses for other imaging devices similar to the imaging device;
storing the list of network addresses on the imaging device; and
referring to the list of network addresses of other imaging devices for communication between imaging devices.

16. The method of claim 15, wherein determining the list of network addresses for other imaging devices similar to the imaging device further comprises discovering the network addresses for other imaging devices similar to the imaging device.

17. The method of claim 16, wherein a discovery manner is selected from the group consisting of querying network addresses for known device specific interface protocols, generally broadcasting a device identification protocol for specific device types to respond to, and pinging network addresses.

18. The method of claim 15, further comprising:
notifying the imaging device when an imaging device associated with a network address of the list of network addresses for other imaging devices goes offline or comes online.

19. The method of claim 16, further comprising storing additional information on the imaging device associated with the list of network address wherein the additional information is selected from the group consisting of media types, marking material types, imaging device features, imaging device configuration, imaging device usage information, imaging device status, imaging device imaging rate, and imaging device supplemental information.

20. The method of claim 15, further comprising:
directing the communication between the imaging device and the other similar imaging devices with a webserver embedded in the imaging device.
